(19) United States
(12) Patent Application Publication
(10) Pub. No.: US 2024/0208184 A1
(43) Pub. Date: Jun. 27, 2024

(54) MULTILAYER LAMINATE STRUCTURE AND METHOD OF FORMING THE SAME

(71) Applicant: SAINT-GOBAIN PERFORMANCE PLASTICS CORPORATION, Solon, OH (US)

(72) Inventors: Rachel MORRISON, Cambridge, MA (US); Gowri DORAIRAJU, Westford, MA (US); Sethumadhavan RAVICHANDRAN, San Diego, CA (US); Vincent PRUD'HOMME, Vernou-Sur-Brenne (FR); Meghann WHITE, Bedford, NH (US); Michael A. ADAMKO, Morristown, NJ (US)

(21) Appl. No.: 18/391,777

(22) Filed: Dec. 21, 2023

Related U.S. Application Data
(60) Provisional application No. 63/476,710, filed on Dec. 22, 2022.

(51) Int. Cl. B32B 17/10; B32B 27/08; B32B 27/18; B32B 27/32; B32B 27/36; B32B 37/16; C08J 5/12; G02B 5/20

(52) U.S. Cl. CPC B32B 17/10; B32B 27/08; B32B 27/18; B32B 27/322; B32B 27/36; B32B 37/16; C08J 5/124; G02B 5/208; B32B 2307/7376; B32B 2315/08; B32B 2323/04; B32B 2367/00; C08J 2327/18

(57) ABSTRACT

The present disclosure relates to a multilayer laminate structure may include a glass substrate having a thickness of not greater than about 300 microns, a fluoropolymer based layer, and an encapsulant layer in contact with the fluoropolymer based layer and between the glass substrate and the fluoropolymer based layer. The encapsulant layer comprises an encapsulant component and a first encapsulant layer ultra violet (UV) absorber component.

### CROSS-REFERENCE TO RELATED APPLICATION(S)

This application claims priority under 35 U.S.C. § 119(c) to U.S. Provisional Patent Application No. 63/476,710, entitled “MULTILAYER LAMINATE STRUCTURE AND METHOD OF FORMING THE SAME,” by Rachel Morrison et al., filed Dec. 22, 2022, which is assigned to the current assignee hereof and is incorporated herein by reference in its entirety.

### FIELD OF THE DISCLOSURE

The present disclosure relates to a multilayer laminate structure, and methods of forming the same. In particular, the present disclosure relates to a multilayer laminate structure for use in laminates for photovoltaic and OLED applications, and methods of forming the same.

### BACKGROUND

Multilayer laminate structures that include fluoropolymer layers have been used as in laminates for photovoltaic and OLED applications due to their excellent weatherability and self-cleaning properties. However, most fluoropolymer materials are also transparent to ultra-violet radiation, and the organic photoactive layers in organic photovoltaics (OPV) are highly susceptible to ultra-violet degradation. Accordingly, improved multilayer laminate structures that demonstrate improved ultra-violet blocking functionality are desired.

### SUMMARY

According to a first aspect, a multilayer laminate structure may include a glass substrate having a thickness of not greater than about 300 microns, a fluoropolymer based layer, and an encapsulant layer in contact with the fluoropolymer based layer and between the glass substrate and the fluoropolymer based layer. The encapsulant layer comprises an encapsulant component and a first encapsulant layer ultra violet (UV) absorber component. The multilayer laminate structure may have a lower ultra-violet light transmission (L-UVLT) of not greater than 1.0%, where the L-UVLT of the multilayer laminate structure is defined as the percent transmission between 200 nm and 360 nm. The multilayer laminate structure may further have a high ultra-violet light transmission (H-UVLT) of not greater than 5.0%, where the H-UVLT of the multilayer laminate structure is defined as the percent transmission between 360 nm and 380 nm. The multilayer laminate structure may include a visual light transmission (VLT) of at least about 50.0%, where the VLT of the multilayer laminate structure is defined as the percent transmission between 400 nm and 1100 nm.

According to another aspect, a method of forming a multilayer laminate structure may include providing a glass substrate having a thickness of not greater than about 300 microns, providing a fluoropolymer based layer, forming an encapsulant layer that is in contact with the fluoropolymer based layer, and attaching the encapsulant layer to the glass substrate so that the encapsulant layer is between the fluoropolymer based layer and the glass substrate. The encapsulant layer comprises an encapsulant component and a first encapsulant layer ultra violet (UV) absorber component. The multilayer laminate structure may have a lower ultra-violet light transmission (L-UVLT) of not greater than 1.0%, where the L-UVLT of the multilayer laminate structure is defined as the percent transmission between 200 nm and 360 nm. The multilayer laminate structure may further have a high ultra-violet light transmission (H-UVLT) of not greater than 5.0%, where the H-UVLT of the multilayer laminate structure is defined as the percent transmission between 360 nm and 380 nm. The multilayer laminate structure may include a visual light transmission (VLT) of at least about 50.0%, where the VLT of the multilayer laminate structure is defined as the percent transmission between 400 nm and 1100 nm.

### BRIEF DESCRIPTION OF THE DRAWINGS

Embodiments are illustrated by way of example and are not limited to the accompanying figures.

FIG. 1 includes a diagram showing a multilayer laminate structure forming method according to embodiments described herein;

FIG. 2 includes an illustration showing the configuration of a multilayer laminate structure formed according to embodiments described herein;

FIG. 3 includes a diagram showing a multilayer laminate structure forming method according to embodiments described herein; and

FIG. 4 includes an illustration showing the configuration of a multilayer laminate structure formed according to embodiments described herein;

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayer laminate structure that may include a thin or ultra-thin glass substrate, a fluoropolymer based layer and an encapsulant layer in contact with the fluoropolymer based layer and between the glass substrate and the fluoropolymer based layer.

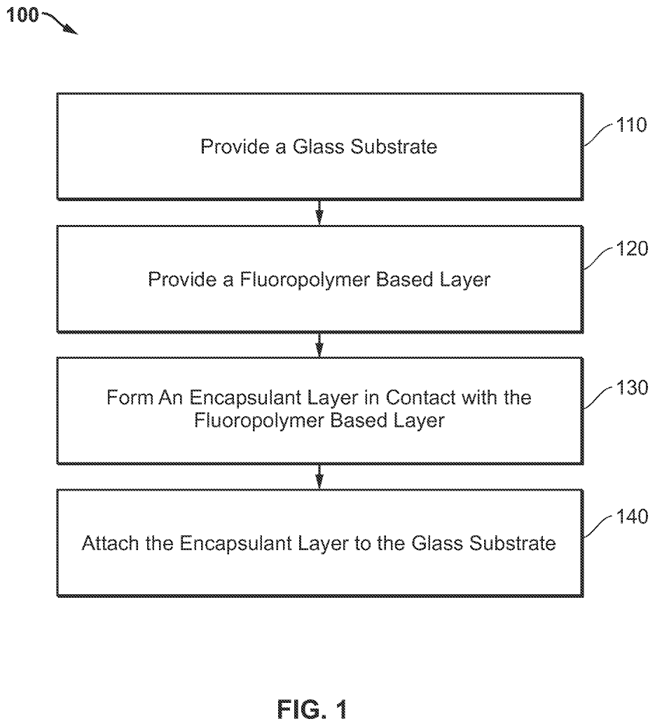

Referring first to a method of forming a multilayer laminate structure, FIG. 1 includes a diagram showing a forming method 100 for forming a multilayer laminate structure according to embodiments described herein. According to particular embodiments, the forming method 100 may include a first step 110 of providing a glass substrate, a second step 120 of providing a fluoropolymer based layer, a third step 130 of forming an encapsulant layer that is in contact with the fluoropolymer based layer, and a fourth step 140 of attaching the encapsulant layer to the glass substrate so that the encapsulant layer is between the fluoropolymer based layer and the glass substrate to form the multilayer laminate structure.

Referring to first step 110, according to particular embodiments, the glass substrate may have a particular thickness. For example, the glass substrate may have a thickness of not greater than about 300 microns, such as, not greater than about 290 microns or not greater than about 280 microns or not greater than about 270 microns or not greater than about 260 microns or not greater than about 250 microns or not greater than about 240 microns or not greater than about 230 microns or not greater than about 220 microns or not greater than about 210 microns or not greater than about 200 microns or not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or even not greater than about 80 microns. According to still other embodiments, the glass substrate may have a thickness of at least about 1 micron, such as, at least about 5 microns or at least about 10 microns or at least about 15 microns or at least about 20 microns or at least about 25 microns or at least about 30 microns. It will be appreciated that the glass substrate thickness may be any value between, and including, any of the minimum and maximum values noted above. It will be further appreciated that the glass substrate thickness may be within a range between, and including, any of the minimum and maximum values noted above.

Referring to the second step 120, according to particular embodiments, the fluoropolymer based layer may include a fluoropolymer based.

According to particular embodiments, the fluoropolymer based material of the fluoropolymer based layer may include a fluoropolymer. According to still other embodiments, the fluoropolymer may be selected from the group consisting of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, and a copolymer of ethylene and trifluoroethylene.

According to still other embodiments, the fluoropolymer may be any blend of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, or a copolymer of ethylene and trifluoroethylene.

According to yet other embodiments, the fluoropolymer may be any alloy of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, or a copolymer of ethylene and trifluoroethylene.

According to yet other embodiments, the fluoropolymer based layer provided in first step 110 may include a particular content of the fluoropolymer based material. For example, the fluoropolymer based layer may include a fluoropolymer based material content of at least about 50 wt. % for a total weight of the fluoropolymer based layer, such as, at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to yet other embodiments, the fluoropolymer based layer may include a fluoropolymer based material content of not greater than about 100 wt. %, for a total weight of the fluoropolymer based layer, such as, not greater than about 98 wt. % or not greater than about 95 wt. % or not greater than about 93 wt. % or not greater than about 90 wt. % or not greater than about 88 wt. % or not greater than about 85 wt. % or not greater than about 83 wt. % or not greater than about 80 wt. % or even not greater than about 78 wt. %. It will be appreciated that the fluoropolymer based material content may be any value between, and including, any of the minimum and maximum values noted above. It will be further appreciated that the fluoropolymer based material content may be within a range between, and including, any of the minimum and maximum values noted above.

According to yet other embodiments, the fluoropolymer based layer provided in first step 120 may include a particular content of ETFE. For example, the fluoropolymer based layer may include an ETFE content of at least about 50 wt. % for a total weight of the fluoropolymer based layer, such as, at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to yet other embodiments, the fluoropolymer based layer may include an ETFE content of not greater than about 100 wt. %, for a total weight of the fluoropolymer based layer, such as, not greater than about 98 wt. % or not greater than about 95 wt. % or not greater than about 93 wt. % or not greater than about 90 wt. % or not greater than about 88 wt. % or not greater than about 85 wt. % or not greater than about 83 wt. % or not greater than about 80 wt. % or even not greater than about 78 wt. %. It will be appreciated that the ETFE content may be any value between, and including, any of the minimum and maximum values noted above. It will be further appreciated that the ETFE content may be within a range between, and including, any of the minimum and maximum values noted above.

According to yet other embodiments, the fluoropolymer based layer provided in first step 120 may consist of ETFE.

According to still other embodiments, the fluoropolymer based layer provided in second step 120 may have a particular thickness. For example, the fluoropolymer based layer may have a thickness of at least about 10 μm, such as, at least about 20 μm or at least about 30 μm or at least about 40 μm or at least about 50 μm or at least about 60 μm or at least about 70 μm or at least about 80 μm or at least about 90 μm or at least about 100 μm or at least about 150 μm or at least about 200 μm or at least about 250 μm or at least about 300 μm or at least about 350 μm or at least about 400 μm or at least about 450 μm or even at least about 500 μm. According to still other embodiments, the fluoropolymer based layer may have a thickness of not greater than about 1000 μm, such as, not greater than about 950 μm or not greater than about 900 μm or not greater than about 850 μm or not greater than about 800 μm or not greater than about 750 μm or not greater than about 700 μm or not greater than about 650 μm or not greater than about 600 μm or even not greater than about 550 μm. It will be appreciated that fluoropolymer based layer thickness may be any value between, and including, any of the minimum and maximum values noted above. It will be further appreciated that the fluoropolymer based layer thickness may be within a range between, and including, any of the minimum and maximum values noted above.

Referring now the third step 130, the encapsulant layer may include an encapsulant component and a first encapsulant layer UV absorber component.

According to particular embodiments, the encapsulant component of the encapsulant layer formed in third step 130 may include a polymer, a thermoplastic polyolefin (TPE), an ethyl vinyl acetate (EVA), a polyvinyl butyrate (PVB) or a silicone. According to still other embodiments, the encapsulant component of the encapsulant layer formed in third step 130 may consist of a polymer, a thermoplastic polyolefin (TPE), an ethyl vinyl acetate (EVA), a polyvinyl butyrate (PVB) or a silicone.

According to yet other embodiments, the encapsulant layer formed in third step 130 may include a particular encapsulant component content. For example, encapsulant layer may have an encapsulant component content may be at least about 35 wt. % for a total weight of the encapsulant layer, such as, at least about 38 wt. % or at least about 40 wt. % or at least about 43 wt. % or at least about 45 wt. % or at least about 48 wt. % or at least about 50 wt. % or at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or at least about 75 wt. %. According to yet other embodiments, the encapsulant layer may have an encapsulant component content of not greater than about 99.95 wt. % for a total weight of the encapsulant layer, such as, not greater than about 99 wt. % or not greater than about 95 wt. % or not greater than about 93 wt. % or not greater than about 90 wt. % or not greater than about 88 wt. % or not greater than about 85 wt. % or not greater than about 83 wt. % or not greater than about 80 wt. % or even not greater than about 78 wt. %. It will be appreciated that the encapsulant component content may be any value between, and including, any of the minimum and maximum values noted above. It will be further appreciated that the encapsulant component content may be within a range between, and including, any of the minimum and maximum values noted above.

According to still other embodiments, the first encapsulant layer UV absorber component of the encapsulant layer formed in step 130 may include a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide. According to yet other embodiments, the first encapsulant layer UV absorber component of the encapsulant layer formed in step 130 may consist of a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

According to yet other embodiments, the encapsulant layer formed in third step 130 may include a particular first encapsulant layer UV absorber component content. For example, encapsulant layer may have an first encapsulant layer UV absorber component content may be at least about 0.05 wt. % for a total weight of the encapsulant layer, such as, at least about 0.5 wt. % or at least about 1.0 wt. % or at least about 3 wt. % or at least about 5 wt. % or at least about 8 wt. % or at least about 10 wt. % or at least about 13 wt. % or at least about 15 wt. % or at least about 18 wt. % or at least about 20 wt. % or at least about 23 wt. % or at least about 25 wt. % or at least about 28 wt. % or at least about 30 wt. % or at least about 33 wt. % or at least about 35 wt. %. According to yet other embodiments, the encapsulant layer may have an first encapsulant layer UV absorber component content of not greater than about 65 wt. % for a total weight of the encapsulant layer, such as, not greater than about 63 wt. % or not greater than about 60 wt. % or not greater than about 58 wt. % or not greater than about 55 wt. % or not greater than about 53 wt. % or not greater than about 50 wt. % or not greater than about 48 wt. % or not greater than about 45 wt. % or even not greater than about 43 wt. %. It will be appreciated that the first encapsulant layer UV absorber component content may be any value between, and including, any of the minimum and maximum values noted above. It will be further appreciated that the first encapsulant layer UV absorber component content may be within a range between, and including, any of the minimum and maximum values noted above.

According to still other embodiments, the encapsulant layer formed in third step 130 may further include a second encapsulant layer UV absorber component.

According to still other embodiments, the second encapsulant layer UV absorber component of the encapsulant layer formed in step 130 may include a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide. According to yet other embodiments, the second encapsulant layer UV absorber component of the encapsulant layer formed in step 130 may consist of a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

According to yet other embodiments, the encapsulant layer formed in third step 130 may include a particular second encapsulant layer UV absorber component content. For example, encapsulant layer may have an second encapsulant layer UV absorber component content may be at least about 0.05 wt. % for a total weight of the encapsulant layer, such as, at least about 0.5 wt. % or at least about 1.0 wt. % or at least about 3 wt. % or at least about 5 wt. % or at least about 8 wt. % or at least about 10 wt. % or at least about 13 wt. % or at least about 15 wt. % or at least about 18 wt. % or at least about 20 wt. % or at least about 23 wt. % or at least about 25 wt. % or at least about 28 wt. % or at least about 30 wt. % or at least about 33 wt. % or at least about 35 wt. %. According to yet other embodiments, the encapsulant layer may have an second encapsulant layer UV absorber component content of not greater than about 65 wt. % for a total weight of the encapsulant layer, such as, not greater than about 63 wt. % or not greater than about 60 wt. % or not greater than about 58 wt. % or not greater than about 55 wt. % or not greater than about 53 wt. % or not greater than about 50 wt. % or not greater than about 48 wt. % or not greater than about 45 wt. % or even not greater than about 43 wt. %. It will be appreciated that the second encapsulant layer UV absorber component content may be any value between, and including, any of the minimum and maximum values noted above. It will be further appreciated that the second encapsulant layer UV absorber component content may be within a range between, and including, any of the minimum and maximum values noted above.

According to still other embodiments, the encapsulant layer provided in third step 130 may have a particular thickness. For example, the encapsulant layer may have a thickness of at least about 30 μm, such as, at least about 35 μm or at least about 40 μm or at least about 45 μm or at least about 50 μm or at least about 55 μm or at least about 60 μm or at least about 30 μm or at least about 40 μm or at least about 50 μm or at least about 60 μm or at least about 70 μm or at least about 80 μm or at least about 90 μm or at least about 100 μm or at least about 150 μm or at least about 200 μm or even at least about 250 μm. According to still other embodiments, the encapsulant layer may have a thickness of not greater than about 500 μm, such as, not greater than about 475 μm or not greater than about 450 μm or not greater than about 425 μm or not greater than about 400 μm or not greater than about 375 μm or not greater than about 350 μm or not greater than about 325 μm or not greater than about 300 μm or even not greater than about 275 μm. It will be appreciated that encapsulant layer thickness may be any value between, and including, any of the minimum and maximum values noted above. It will be further appreciated that the encapsulant layer thickness may be within a range between, and including, any of the minimum and maximum values noted above.

According to still other embodiments, the encapsulant layer provided in third step 130 may have a corona-treated surface. According to still other embodiments, the corona-treated surface of the encapsulant layer may contact the fluoropolymer based layer.

Referring back to the second step 120, according to other embodiments, the fluoropolymer based layer may further include a first fluoropolymer based layer UV absorber component.

According to still other embodiments, the first fluoropolymer based layer UV absorber component of the fluoropolymer based layer formed in second step 120 may include a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide. According to yet other embodiments, the first fluoropolymer based layer UV absorber component of the fluoropolymer based layer formed in the first step 110 may consist of a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

According to yet other embodiments, the fluoropolymer based layer formed in second step 120 may include a particular first fluoropolymer based layer UV absorber component content. For example, fluoropolymer based layer may have an first fluoropolymer based layer UV absorber component content may be at least about 0.05 wt. % for a total weight of the fluoropolymer based layer, such as, at least about 0.5 wt. % or at least about 1.0 wt. % or at least about 3 wt. % or at least about 5 wt. % or at least about 8 wt. % or at least about 10 wt. % or at least about 13 wt. % or at least about 15 wt. % or at least about 18 wt. % or at least about 20 wt. % or at least about 23 wt. % or at least about 25 wt. % or at least about 28 wt. % or at least about 30 wt. % or at least about 33 wt. % or at least about 35 wt. %. According to yet other embodiments, the fluoropolymer based layer may have an first fluoropolymer based layer UV absorber component content of not greater than about 65 wt. % for a total weight of the fluoropolymer based layer, such as, not greater than about 63 wt. % or not greater than about 60 wt. % or not greater than about 58 wt. % or not greater than about 55 wt. % or not greater than about 53 wt. % or not greater than about 50 wt. % or not greater than about 48 wt. % or not greater than about 45 wt. % or even not greater than about 43 wt. %. It will be appreciated that the first fluoropolymer based layer UV absorber component content may be any value between, and including, any of the minimum and maximum values noted above. It will be further appreciated that the first fluoropolymer based layer UV absorber component content may be within a range between, and including, any of the minimum and maximum values noted above.

According to still other embodiments, the fluoropolymer based layer formed in second step 120 may further include a second fluoropolymer based layer UV absorber component.

According to still other embodiments, the second fluoropolymer based layer UV absorber component of the fluoropolymer based layer formed in second step 120 may include a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide. According to yet other embodiments, the second fluoropolymer based layer UV absorber component of the fluoropolymer based layer formed in second step 120 may consist of a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

According to yet other embodiments, the fluoropolymer based layer formed in second step 120 may include particular second fluoropolymer based layer UV absorber component content. For example, fluoropolymer based layer may have an second fluoropolymer based layer UV absorber component content may be at least about 0.05 wt. % for a total weight of the fluoropolymer based layer, such as, at least about 0.5 wt. % or at least about 1.0 wt. % or at least about 3 wt. % or at least about 5 wt. % or at least about 8 wt. % or at least about 10 wt. % or at least about 13 wt. % or at least about 15 wt. % or at least about 18 wt. % or at least about 20 wt. % or at least about 23 wt. % or at least about 25 wt. % or at least about 28 wt. % or at least about 30 wt. % or at least about 33 wt. % or at least about 35 wt. %. According to yet other embodiments, the fluoropolymer based layer may have an second fluoropolymer based layer UV absorber component content of not greater than about 65 wt. % for a total weight of the fluoropolymer based layer, such as, not greater than about 63 wt. % or not greater than about 60 wt. % or not greater than about 58 wt. % or not greater than about 55 wt. % or not greater than about 53 wt. % or not greater than about 50 wt. % or not greater than about 48 wt. % or not greater than about 45 wt. % or even not greater than about 43 wt. %. It will be appreciated that the second fluoropolymer based layer UV absorber component content may be any value between, and including, any of the minimum and maximum values noted above. It will be further appreciated that the second fluoropolymer based layer UV absorber component content may be within a range between, and including, any of the minimum and maximum values noted above.

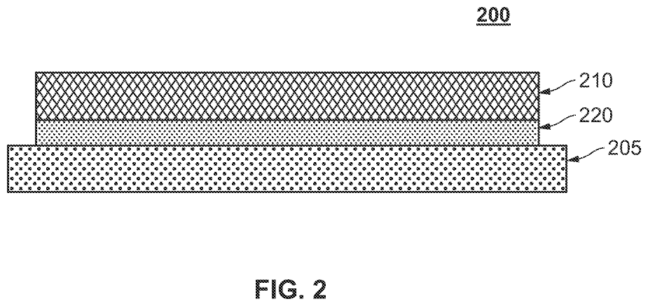

Referring now to embodiments of the multilayer laminate structure formed according to forming method 100, FIG. 2 includes diagram of a multilayer laminate structure 200. As shown in FIG. 2, the multilayer laminate structure 200 may include a glass substrate 205, a fluoropolymer based layer 210, and an encapsulant layer 220 in contact with the fluoropolymer based layer 210 and between the glass substrate 205 and the fluoropolymer based layer 210.

According to particular embodiments, the glass substrate 205 may have a particular thickness. For example, the glass substrate 205 may have a thickness of not greater than about 300 microns, such as, not greater than about 290 microns or not greater than about 280 microns or not greater than about 270 microns or not greater than about 260 microns or not greater than about 250 microns or not greater than about 240 microns or not greater than about 230 microns or not greater than about 220 microns or not greater than about 210 microns or not greater than about 200 microns or not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or even not greater than about 80 microns. According to still other embodiments, the glass substrate 205 may have a thickness of at least about 1 micron, such as, at least about 5 microns or at least about 10 microns or at least about 15 microns or at least about 20 microns or at least about 25 microns or at least about 30 microns. It will be appreciated that the glass substrate 205 thickness may be any value between, and including, any of the minimum and maximum values noted above. It will be further appreciated that the glass substrate 205 thickness may be within a range between, and including, any of the minimum and maximum values noted above.

According to particular embodiments, the fluoropolymer based layer 210 may include a fluoropolymer based material.

According to particular embodiments, the fluoropolymer based material of the fluoropolymer based layer 210 may include a fluoropolymer. According to still other embodiments, the fluoropolymer may be selected from the group consisting of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, and a copolymer of ethylene and trifluoroethylene.

According to still other embodiments, the fluoropolymer may be any blend of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, or a copolymer of ethylene and trifluoroethylene.

According to yet other embodiments, the fluoropolymer may be any alloy of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, or a copolymer of ethylene and trifluoroethylene.

According to yet other embodiments, the fluoropolymer based layer 210 may include a particular content of the fluoropolymer based material. For example, the fluoropolymer based layer 210 may include a fluoropolymer based material content of at least about 50 wt. % for a total weight of the fluoropolymer based layer 210, such as, at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to yet other embodiments, the fluoropolymer based layer 210 may include a fluoropolymer based material content of not greater than about 100 wt. %, for a total weight of the fluoropolymer based layer 210, such as, not greater than about 98 wt. % or not greater than about 95 wt. % or not greater than about 93 wt. % or not greater than about 90 wt. % or not greater than about 88 wt. % or not greater than about 85 wt. % or not greater than about 83 wt. % or not greater than about 80 wt. % or even not greater than about 78 wt. %. It will be appreciated that the fluoropolymer based material content may be any value between, and including, any of the minimum and maximum values noted above. It will be further appreciated that the fluoropolymer based material content may be within a range between, and including, any of the minimum and maximum values noted above.

According to yet other embodiments, the fluoropolymer based layer 210 may include a particular content of ETFE. For example, the fluoropolymer based layer 210 may include an ETFE content of at least about 50 wt. % for a total weight of the fluoropolymer based layer 210, such as, at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to yet other embodiments, the fluoropolymer based layer 210 may include an ETFE content of not greater than about 100 wt. %, for a total weight of the fluoropolymer based layer 210, such as, not greater than about 98 wt. % or not greater than about 95 wt. % or not greater than about 93 wt. % or not greater than about 90 wt. % or not greater than about 88 wt. % or not greater than about 85 wt. % or not greater than about 83 wt. % or not greater than about 80 wt. % or even not greater than about 78 wt. %. It will be appreciated that the ETFE content may be any value between, and including, any of the minimum and maximum values noted above. It will be further appreciated that the ETFE content may be within a range between, and including, any of the minimum and maximum values noted above.

According to yet other embodiments, the fluoropolymer based layer 210 may consist of ETFE.

According to still other embodiments, the fluoropolymer based layer 210 may have a particular thickness. For example, the fluoropolymer based layer 210 may have a thickness of at least about 10 μm, such as, at least about 20 μm or at least about 30 μm or at least about 40 μm or at least about 50 μm or at least about 60 μm or at least about 70 μm or at least about 80 μm or at least about 90 μm or at least about 100 μm or at least about 150 μm or at least about 200 μm or at least about 250 μm or at least about 300 μm or at least about 350 μm or at least about 400 μm or at least about 450 μm or even at least about 500 μm. According to still other embodiments, the fluoropolymer based layer 210 may have a thickness of not greater than about 1000 μm, such as, not greater than about 950 μm or not greater than about 900 μm or not greater than about 850 μm or not greater than about 800 μm or not greater than about 750 μm or not greater than about 700 μm or not greater than about 650 μm or not greater than about 600 μm or even not greater than about 550 μm. It will be appreciated that fluoropolymer based layer 210 thickness may be any value between, and including, any of the minimum and maximum values noted above. It will be further appreciated that the fluoropolymer based layer 210 thickness may be within a range between, and including, any of the minimum and maximum values noted above.

According to still other embodiments, the encapsulant layer 220 may include an encapsulant component and a first encapsulant layer UV absorber component.

According to particular embodiments, the encapsulant component of the encapsulant layer 220 may include a polymer, a thermoplastic polyolefin (TPE), an ethyl vinyl acetate (EVA), a polyvinyl butyrate (PVB) or a silicone. According to still other embodiments, the encapsulant component of the encapsulant layer 220 may consist of a polymer, a thermoplastic polyolefin (TPE), an ethyl vinyl acetate (EVA), a polyvinyl butyrate (PVB) or a silicone.

According to yet other embodiments, the encapsulant layer 220 may include a particular encapsulant component content. For example, encapsulant layer 220 may have an encapsulant component content may be at least about 35 wt. % for a total weight of the encapsulant layer 220, such as, at least about 38 wt. % or at least about 40 wt. % or at least about 43 wt. % or at least about 45 wt. % or at least about 48 wt. % or at least about 50 wt. % or at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or at least about 75 wt. %. According to yet other embodiments, the encapsulant layer 220 may have an encapsulant component content of not greater than about 99.95 wt. % for a total weight of the encapsulant layer 220, such as, not greater than about 99 wt. % or not greater than about 95 wt. % or not greater than about 93 wt. % or not greater than about 90 wt. % or not greater than about 88 wt. % or not greater than about 85 wt. % or not greater than about 83 wt. % or not greater than about 80 wt. % or even not greater than about 78 wt. %. It will be appreciated that the encapsulant component content may be any value between, and including, any of the minimum and maximum values noted above. It will be further appreciated that the encapsulant component content may be within a range between, and including, any of the minimum and maximum values noted above.

According to still other embodiments, the first encapsulant layer UV absorber component of the encapsulant layer 220 may include a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide. According to yet other embodiments, the first encapsulant layer UV absorber component of the encapsulant layer 220 may consist of a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

According to yet other embodiments, the encapsulant layer 220 may include a particular first encapsulant layer UV absorber component content. For example, encapsulant layer 220 may have an first encapsulant layer UV absorber component content may be at least about 0.05 wt. % for a total weight of the encapsulant layer 220, such as, at least about 0.5 wt. % or at least about 1.0 wt. % or at least about 3 wt. % or at least about 5 wt. % or at least about 8 wt. % or at least about 10 wt. % or at least about 13 wt. % or at least about 15 wt. % or at least about 18 wt. % or at least about 20 wt. % or at least about 23 wt. % or at least about 25 wt. % or at least about 28 wt. % or at least about 30 wt. % or at least about 33 wt. % or at least about 35 wt. %. According to yet other embodiments, the encapsulant layer 220 may have an first encapsulant layer UV absorber component content of not greater than about 65 wt. % for a total weight of the encapsulant layer 220, such as, not greater than about 63 wt. % or not greater than about 60 wt. % or not greater than about 58 wt. % or not greater than about 55 wt. % or not greater than about 53 wt. % or not greater than about 50 wt. % or not greater than about 48 wt. % or not greater than about 45 wt. % or even not greater than about 43 wt. %. It will be appreciated that the first encapsulant layer UV absorber component content may be any value between, and including, any of the minimum and maximum values noted above. It will be further appreciated that the first encapsulant layer UV absorber component content may be within a range between, and including, any of the minimum and maximum values noted above.

According to still other embodiments, the encapsulant layer 220 may further include a second encapsulant layer UV absorber component.

According to still other embodiments, the second encapsulant layer UV absorber component of the encapsulant layer 220 may include a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide. According to yet other embodiments, the second encapsulant layer UV absorber component of the encapsulant layer 220 may consist of a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

According to yet other embodiments, the encapsulant layer 220 may include a particular second encapsulant layer UV absorber component content. For example, encapsulant layer 220 may have an second encapsulant layer UV absorber component content may be at least about 0.05 wt. % for a total weight of the encapsulant layer 220, such as, at least about 0.5 wt. % or at least about 1.0 wt. % or at least about 3 wt. % or at least about 5 wt. % or at least about 8 wt. % or at least about 10 wt. % or at least about 13 wt. % or at least about 15 wt. % or at least about 18 wt. % or at least about 20 wt. % or at least about 23 wt. % or at least about 25 wt. % or at least about 28 wt. % or at least about 30 wt. % or at least about 33 wt. % or at least about 35 wt. %. According to yet other embodiments, the encapsulant layer 220 may have an second encapsulant layer UV absorber component content of not greater than about 65 wt. % for a total weight of the encapsulant layer 220, such as, not greater than about 63 wt. % or not greater than about 60 wt. % or not greater than about 58 wt. % or not greater than about 55 wt. % or not greater than about 53 wt. % or not greater than about 50 wt. % or not greater than about 48 wt. % or not greater than about 45 wt. % or even not greater than about 43 wt. %. It will be appreciated that the second encapsulant layer UV absorber component content may be any value between, and including, any of the minimum and maximum values noted above. It will be further appreciated that the second encapsulant layer UV absorber component content may be within a range between, and including, any of the minimum and maximum values noted above.

According to still other embodiments, the encapsulant layer 220 may have a particular thickness. For example, the encapsulant layer 220 may have a thickness of at least about 30 μm, such as, at least about 35 μm or at least about 40 μm or at least about 45 μm or at least about 50 μm or at least about 55 μm or at least about 60 μm or at least about 30 μm or at least about 40 μm or at least about 50 μm or at least about 60 μm or at least about 70 μm or at least about 80 μm or at least about 90 μm or at least about 100 μm or at least about 150 μm or at least about 200 μm or even at least about 250 μm. According to still other embodiments, the encapsulant layer 220 may have a thickness of not greater than about 500 μm, such as, not greater than about 475 μm or not greater than about 450 μm or not greater than about 425 μm or not greater than about 400 μm or not greater than about 375 μm or not greater than about 350 μm or not greater than about 325 μm or not greater than about 300 μm or even not greater than about 275 μm. It will be appreciated that encapsulant layer 220 thickness may be any value between, and including, any of the minimum and maximum values noted above. It will be further appreciated that the encapsulant layer 220 thickness may be within a range between, and including, any of the minimum and maximum values noted above.

According to still other embodiments, the encapsulant layer 220 may have a corona-treated surface. According to still other embodiments, the corona-treated surface of the encapsulant layer 220 may contact the fluoropolymer based layer 210.

According to other embodiments, the fluoropolymer based layer 210 may further include a first fluoropolymer based layer UV absorber component.

According to still other embodiments, the first fluoropolymer based layer UV absorber component of the fluoropolymer based layer 210 may include a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide. According to yet other embodiments, the first fluoropolymer based layer UV absorber component of the fluoropolymer based layer 210 may consist of a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

According to yet other embodiments, the fluoropolymer based layer 210 may include a particular first fluoropolymer based layer UV absorber component content. For example, fluoropolymer based layer 210 may have an first fluoropolymer based layer UV absorber component content may be at least about 0.05 wt. % for a total weight of the fluoropolymer based layer 210, such as, at least about 0.5 wt. % or at least about 1.0 wt. % or at least about 3 wt. % or at least about 5 wt. % or at least about 8 wt. % or at least about 10 wt. % or at least about 13 wt. % or at least about 15 wt. % or at least about 18 wt. % or at least about 20 wt. % or at least about 23 wt. % or at least about 25 wt. % or at least about 28 wt. % or at least about 30 wt. % or at least about 33 wt. % or at least about 35 wt. %. According to yet other embodiments, the fluoropolymer based layer 210 may have an first fluoropolymer based layer UV absorber component content of not greater than about 65 wt. % for a total weight of the fluoropolymer based layer 210, such as, not greater than about 63 wt. % or not greater than about 60 wt. % or not greater than about 58 wt. % or not greater than about 55 wt. % or not greater than about 53 wt. % or not greater than about 50 wt. % or not greater than about 48 wt. % or not greater than about 45 wt. % or even not greater than about 43 wt. %. It will be appreciated that the first fluoropolymer based layer UV absorber component content may be any value between, and including, any of the minimum and maximum values noted above. It will be further appreciated that the first fluoropolymer based layer UV absorber component content may be within a range between, and including, any of the minimum and maximum values noted above.

According to still other embodiments, the fluoropolymer based layer 210 may further include a second fluoropolymer based layer UV absorber component.

According to still other embodiments, the second fluoropolymer based layer UV absorber component of the fluoropolymer based layer 210 may include a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide. According to yet other embodiments, the second fluoropolymer based layer UV absorber component of the fluoropolymer based layer 210 may consist of a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

According to yet other embodiments, the fluoropolymer based layer 210 may include particular second fluoropolymer based layer UV absorber component content. For example, fluoropolymer based layer 210 may have an second fluoropolymer based layer UV absorber component content may be at least about 0.05 wt. % for a total weight of the fluoropolymer based layer 210, such as, at least about 0.5 wt. % or at least about 1.0 wt. % or at least about 3 wt. % or at least about 5 wt. % or at least about 8 wt. % or at least about 10 wt. % or at least about 13 wt. % or at least about 15 wt. % or at least about 18 wt. % or at least about 20 wt. % or at least about 23 wt. % or at least about 25 wt. % or at least about 28 wt. % or at least about 30 wt. % or at least about 33 wt. % or at least about 35 wt. %. According to yet other embodiments, the fluoropolymer based layer 210 may have an second fluoropolymer based layer UV absorber component content of not greater than about 65 wt. % for a total weight of the fluoropolymer based layer 210, such as, not greater than about 63 wt. % or not greater than about 60 wt. % or not greater than about 58 wt. % or not greater than about 55 wt. % or not greater than about 53 wt. % or not greater than about 50 wt. % or not greater than about 48 wt. % or not greater than about 45 wt. % or even not greater than about 43 wt. %. It will be appreciated that the second fluoropolymer based layer UV absorber component content may be any value between, and including, any of the minimum and maximum values noted above. It will be further appreciated that the second fluoropolymer based layer UV absorber component content may be within a range between, and including, any of the minimum and maximum values noted above.

According to still other embodiments, the multilayer laminate structure 200 may have a particular lower ultra-violet light transmission (L-UVLT). For purposes of embodiments described herein, a lower ultra-violet light transmission (L-UVLT) of a multilayer laminate structure is defined as the percent transmission between 200 nm and 360 nm as measured according to ASTM D1003. According to particular embodiments, the multilayer laminate structure 200 may have a L-UVLT of not greater than about 1.0%, such as, not greater than about 0.95% or not greater than about 0.9% or not greater than about 0.8% or not greater than about 0.75% or not greater than about 0.7% or not greater than about 0.65% or not greater than about 0.6% or not greater than about 0.55% or not greater than about 0.5% or not greater than about 0.45% or not greater than about 0.4% or not greater than about 0.35% or not greater than about 0.3% or not greater than about 0.25% or not greater than about 0.2% or not greater than about 0.15% or even not greater than about 0.1%. According to still other embodiments, the multilayer laminate structure 200 may have a L-UVLT of at least about 0.0001%, such as, at least about 0.0005%. It will be appreciated that the L-UVLT of the multilayer laminate structure 200 may be any value between, and including, any of the minimum and maximum values noted above. It will be further appreciated that the L-UVLT of the multilayer laminate structure 200 may be within a range between, and including, any of the minimum and maximum values noted above.

According to still other embodiments, the multilayer laminate structure 200 may have a particular high ultra-violet light transmission (H-UVLT). For purposes of embodiments described herein, a high ultra-violet light transmission (H-UVLT) of a multilayer laminate structure is defined as the percent transmission between 360 nm and 380 nm as measured according to ASTM D1003. According to particular embodiments, the multilayer laminate structure 200 may have a H-UVLT of not greater than about 5.0%, such as, not greater than about 4.9% or not greater than about 4.8% or not greater than about 4.7% or not greater than about 4.6% or not greater than about 4.5% or not greater than about 4.0% or not greater than about 3.5% or not greater than about 3.0% or not greater than about 2.5% or not greater than about 2.0%. According to still other embodiments, the multilayer laminate structure 200 may have a H-UVLT of at least about 0.0001%, such as, at least about 0.0005%. It will be appreciated that the H-UVLT of the multilayer laminate structure 200 may be any value between, and including, any of the minimum and maximum values noted above. It will be further appreciated that the H-UVLT of the multilayer laminate structure 200 may be within a range between, and including, any of the minimum and maximum values noted above.

According to still other embodiments, the multilayer laminate structure 200 may have a particular visual light transmission (VLT). For purposes of embodiments described herein, a visual light transmission (VLT) of a multilayer laminate structure is defined as the percent transmission between 400 nm and 1100 nm as measured according to ASTM D1003. According to particular embodiments, the multilayer laminate structure 200 may have a VLT of at least about 50.0%, such as, at least about 55.0% or at least about 60.0% or at least about 65.0% or at least about 70.0% or at least about 73.0% or at least about 75.0% or at least about 78.0% or at least about 80.0% or at least about 83.0% or at least about 85.0%. According to still other embodiments, the multilayer laminate structure 200 may have a VLT of not greater than about 99.9%. It will be appreciated that the VLT of the multilayer laminate structure 200 may be any value between, and including, any of the minimum and maximum values noted above. It will be further appreciated that the VLT of the multilayer laminate structure 200 may be within a range between, and including, any of the minimum and maximum values noted above.

Referring to alternative embodiments described herein, embodiments are generally directed to a multilayer laminate structure that may include a thin or ultra-thin glass substrate, a fluoropolymer based layer, a PET layer, and an encapsulant layer in contact with the fluoropolymer based layer and in between the fluoropolymer based layer and the PET layer.

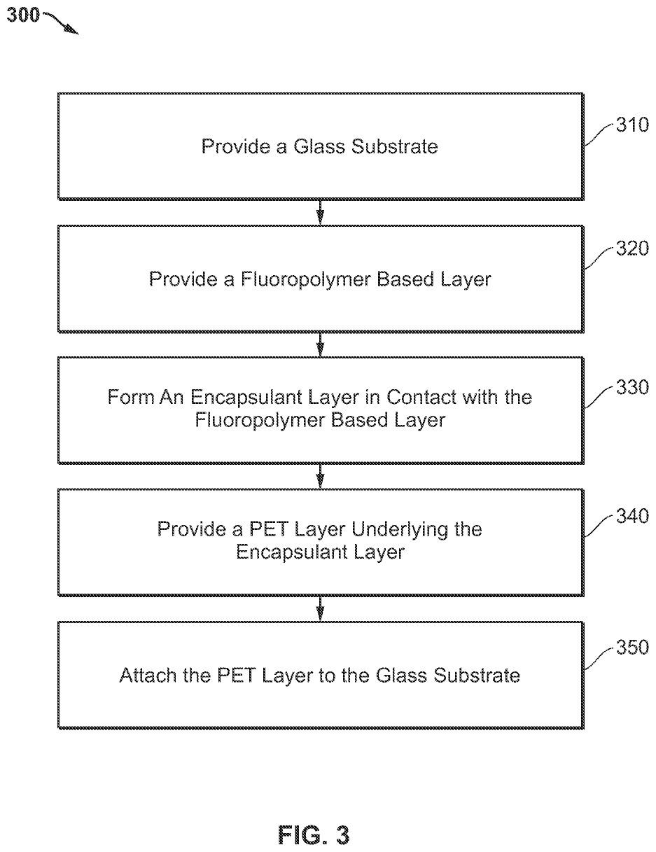

A method of forming a multilayer laminate structure, FIG. 3 includes a diagram showing a forming method 300 for forming a multilayer laminate structure according to embodiments described herein. According to particular embodiments, the forming method 300 may include a first step 310 of providing a glass substrate, a second step 320 of providing a fluoropolymer based layer, a third step 330 of forming an encapsulant layer that is in contact with the fluoropolymer based layer, a fourth step 340 of providing a PET layer underlying the encapsulant layer so that the encapsulant layer is between the fluoropolymer based layer and the PET layer, and a fifth step 350 of attaching the PET layer to the glass substrate so that the PET layer is between the fluoropolymer based layer and the glass substrate to form the multilayer laminate structure.

It will be appreciated that all description, details and characteristics provided herein in reference to forming method 100 may further apply to or describe correspond aspects of forming method 300.

Referring specifically to the fourth step 340, the PET layer may have a particular thickness. For example, the PET layer provided in third step 340 may have a thickness of at least about 10 μm, such as, at least about 20 μm or at least about 30 μm or at least about 40 μm or at least about 50 μm or at least about 60 μm or at least about 70 μm or at least about 80 μm or at least about 90 μm or at least about 100 μm or at least about 150 μm or at least about 200 μm or at least about 250 μm or at least about 300 μm or at least about 350 μm or at least about 400 μm or at least about 450 μm or even at least about 500 μm. According to still other embodiments, the PET layer provided in third step 340 may have a thickness of not greater than about 1000 μm, such as, not greater than about 950 μm or not greater than about 900 μm or not greater than about 850 μm or not greater than about 800 μm or not greater than about 750 μm or not greater than about 700 μm or not greater than about 650 μm or not greater than about 600 μm or even not greater than about 550 μm. It will be appreciated that the PET layer thickness may be any value between, and including, any of the minimum and maximum values noted above. It will be further appreciated that the PET layer thickness may be within a range between, and including, any of the minimum and maximum values noted above.

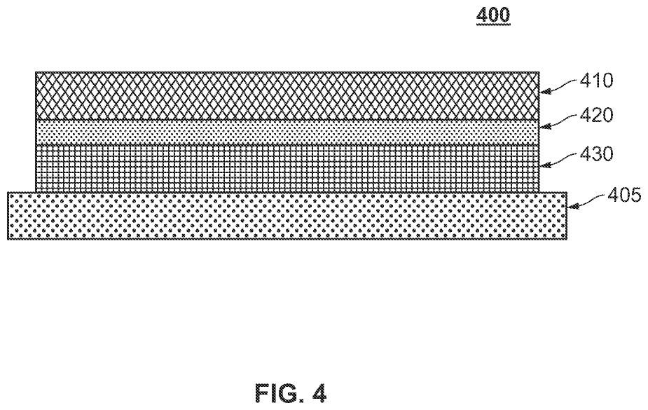

Referring now to embodiments of the multilayer laminate structure formed according to forming method 300, FIG. 4 includes diagram of a multilayer laminate structure 400. As shown in FIG. 4, the multilayer laminate structure 400 may include a glass substrate 205, a fluoropolymer based layer 410, an encapsulant layer 420, and a PET layer 430. As shown in FIG. 4, the encapsulant layer 420 is in contact with the fluoropolymer based layer 410, and the PET layer 430 is in between the fluoropolymer based layer 410 and glass substrate 205.

Again, it will be appreciated that all description provided herein in reference to multilayer laminate structure 200 may further apply to corresponding aspects of the multilayer laminate structure 400, including all component of multilayer laminate structure 400.

According to particular embodiments, the PET layer 430 may have a thickness of at least about 10 μm, such as, at least about 20 μm or at least about 30 μm or at least about 40 μm or at least about 50 μm or at least about 60 μm or at least about 70 μm or at least about 80 μm or at least about 90 μm or at least about 100 μm or at least about 150 μm or at least about 200 μm or at least about 250 μm or at least about 300 μm or at least about 350 μm or at least about 400 μm or at least about 450 μm or even at least about 500 μm. According to still other embodiments, the PET layer 430 may have a thickness of not greater than about 1000 μm, such as, not greater than about 950 μm or not greater than about 900 μm or not greater than about 850 μm or not greater than about 800 μm or not greater than about 750 μm or not greater than about 700 μm or not greater than about 650 μm or not greater than about 600 μm or even not greater than about 550 μm. It will be appreciated that the PET layer 430 thickness may be any value between, and including, any of the minimum and maximum values noted above. It will be further appreciated that the PET layer 430 thickness may be within a range between, and including, any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A multilayer laminate structure comprising: a glass substrate having a thickness of not greater than about 300 microns, an fluoropolymer based layer comprising a fluoropolymer based material, and an encapsulant layer in contact with the glass substrate and the fluoropolymer based layer, wherein the encapsulant layer comprises an encapsulant component and a first encapsulant layer ultra violet (UV) absorber component, wherein the multilayer laminate structure comprises a lower ultra-violet light transmission (L-UVLT) of not greater than 1.0%, where the L-UVLT of the multilayer laminate structure is defined as the percent transmission between 200 nm and 360 nm, wherein the multilayer laminate structure comprises a high ultra-violet light transmission (H-UVLT) of not greater than 5.0%, where the H-UVLT of the multilayer laminate structure is defined as the percent transmission between 360 nm and 380 nm, and wherein the multilayer laminate structure comprises a visual light transmission (VLT) of at least about 50.0%, where the VLT of the multilayer laminate structure is defined as the percent transmission between 400 nm and 1100 nm.

Embodiment 2. The multilayer laminate structure of embodiment 1, wherein the multilayer laminate structure comprises a L-UVLT of not greater than about 0.95%.

Embodiment 3. The multilayer laminate structure of embodiment 1, wherein the multilayer laminate structure comprises a L-UVLT of at least about 0.0001%.

Embodiment 4. The multilayer laminate structure of embodiment 1, wherein the multilayer laminate structure comprises a H-UVLT of not greater than about 4.9%.

Embodiment 5. The multilayer laminate structure of embodiment 1, wherein the multilayer laminate structure comprises a H-UVLT of at least about 0.0001%.

Embodiment 6. The multilayer laminate structure of embodiment 1, wherein the multilayer laminate structure comprises a VLT of at least about 55.0%.

Embodiment 7. The multilayer laminate structure of embodiment 1, wherein the multilayer laminate structure comprises a VLT of not greater than about 99.9%.

Embodiment 8. The multilayer laminate structure of embodiment 1, wherein the glass substrate has a thickness of not greater than about 300 microns.

Embodiment 9. The multilayer laminate structure of embodiment 1, wherein the glass substrate has a thickness of at least about 1 micron.

Embodiment 10. The multilayer laminate structure of embodiment 1, wherein the fluoropolymer based material of the fluoropolymer based layer comprises a fluoropolymer.

Embodiment 11. The multilayer laminate structure of embodiment 10, wherein the fluoropolymer is selected from the group consisting of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, a copolymer of ethylene and trifluoroethylene, any blend thereof, and any alloy thereof.

Embodiment 12. The multilayer laminate structure of embodiment 1, wherein the fluoropolymer based layer comprises a fluoropolymer based material content of at least about 50 wt. % for a total weight of the fluoropolymer based layer.

Embodiment 13. The multilayer laminate structure of embodiment 1, wherein the fluoropolymer based layer comprises a fluoropolymer based material content of not greater than about 100% for a total weight of the fluoropolymer based layer.

Embodiment 14. The multilayer laminate structure of embodiment 1, wherein the fluoropolymer based layer consists of a fluoropolymer based material.

Embodiment 15. The multilayer laminate structure of embodiment 1, wherein the fluoropolymer based layer comprises an ETFE content of at least about 50 wt. % for a total weight of the fluoropolymer based layer.

Embodiment 16. The multilayer laminate structure of embodiment 1, wherein the fluoropolymer based layer comprises an ETFE content of not greater than about 100 wt. % for a total weight of the fluoropolymer based layer.

Embodiment 17. The multilayer laminate structure of embodiment 1, wherein the fluoropolymer based layer consists of an ETFE.

Embodiment 18. The multilayer laminate structure of embodiment 1, wherein the fluoropolymer based layer comprises a thickness of at least about 10 μm.

Embodiment 19. The multilayer laminate structure of embodiment 1, wherein the fluoropolymer based layer comprises a thickness of not greater than about 1000 μm.

Embodiment 20. The multilayer laminate structure of embodiment 1, wherein the encapsulant layer comprises an encapsulant component and a first encapsulant layer UV absorber component.

Embodiment 21. The multilayer laminate structure of embodiment 20, wherein the encapsulant layer comprises an encapsulant component content of at least about 35 wt. % for a total weight of the encapsulant layer.

Embodiment 22. The multilayer laminate structure of embodiment 20, wherein the encapsulant layer comprises an encapsulant component content of not greater than about 99.95 wt. % for a total weight of the encapsulant layer.

Embodiment 23. The multilayer laminate structure of embodiment 20, wherein the encapsulant component comprises a polymer, a thermoplastic polyolefin (TPE), an ethyl vinyl acetate (EVA), a polyvinyl butyrate (PVB) or a silicone.

Embodiment 24. The multilayer laminate structure of embodiment 20, wherein the encapsulant layer comprises a first encapsulant layer UV absorber component content of at least about 0.05 wt. % for a total weight of the encapsulant layer.

Embodiment 25. The multilayer laminate structure of embodiment 20, wherein the encapsulant layer comprises a first encapsulant layer UV absorber component content of not greater than about 65 wt. % for a total weight of the encapsulant layer.

Embodiment 26. The multilayer laminate structure of embodiment 20, wherein the first encapsulant layer UV absorber component comprises a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

Embodiment 27. The multilayer laminate structure of embodiment 20, wherein the encapsulant layer comprises a second encapsulant layer UV absorber component.

Embodiment 28. The multilayer laminate structure of embodiment 27, wherein the encapsulant layer comprises a second encapsulant layer UV absorber component content of at least about 0.05 wt. % for a total weight of the encapsulant layer.

Embodiment 29. The multilayer laminate structure of embodiment 27, wherein the encapsulant layer comprises a second UV encapsulant layer absorber component content of not greater than about 65 wt. % for a total weight of the encapsulant layer.

Embodiment 30. The multilayer laminate structure of embodiment 27, wherein second encapsulant layer UV absorber component comprises a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

Embodiment 31. The multilayer laminate structure of embodiment 1, wherein the encapsulant layer comprises a thickness of at least about 30 μm.

Embodiment 32. The multilayer laminate structure of embodiment 1, wherein the encapsulant layer comprises a thickness of not greater than about 500 μm.

Embodiment 33. The multilayer laminate structure of embodiment 1, wherein the encapsulant layer comprises a corona-treated surface.

Embodiment 34. The multilayer laminate structure of embodiment 33, where the corona-treated surface contacts the fluoropolymer based layer.

Embodiment 35. The multilayer laminate structure of embodiment 1, wherein the multilayer film further comprises a PET layer, wherein the encapsulant layer is between the fluoropolymer based layer and the PET layer.

Embodiment 36. The multilayer laminate structure of embodiment 35, wherein the PET layer comprises a thickness of at least about 0.1 μm.

Embodiment 37. The multilayer laminate structure of embodiment 35, wherein the PET layer comprises a thickness of not greater than about 1000 μm.

Embodiment 38. The multilayer laminate structure of embodiment 1, wherein the fluoropolymer based layer comprises a first fluoropolymer based layer UV absorber component.

Embodiment 39. The multilayer laminate structure of embodiment 38, wherein the fluoropolymer based layer comprises a first fluoropolymer based layer UV absorber component content of at least about 0.05 wt. % for a total weight of the fluoropolymer based layer.

Embodiment 40. The multilayer laminate structure of embodiment 38, wherein the fluoropolymer based layer comprises a first fluoropolymer based layer UV absorber component content of not greater than about 65 wt. % for a total weight of the fluoropolymer based layer.

Embodiment 41. The multilayer laminate structure of embodiment 38, wherein the first fluoropolymer based layer UV absorber component comprises a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

Embodiment 42. The multilayer laminate structure of embodiment 38, wherein the fluoropolymer based layer comprises a second fluoropolymer based layer UV absorber component.

Embodiment 43. The multilayer laminate structure of embodiment 42, wherein the fluoropolymer based layer comprises a second fluoropolymer based layer UV absorber component content of at least about 0.05 wt. % for a total weight of the fluoropolymer based layer.

Embodiment 44. The multilayer laminate structure of embodiment 42, wherein the fluoropolymer based layer comprises a second fluoropolymer based layer UV absorber component content of not greater than about 65 wt. % for a total weight of the fluoropolymer based layer.

Embodiment 45. The multilayer laminate structure of embodiment 42, wherein second fluoropolymer based layer UV absorber component comprises a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

Embodiment 46. A method of forming a multilayer laminate structure, wherein the method comprises: providing a glass substrate having a thickness of not greater than about 300 microns, providing a fluoropolymer based layer, forming an encapsulant layer so that it is in contact with the fluoropolymer based layer, attaching the encapsulant layer to the glass substrate so that the encapsulant layer is between the fluoropolymer based layer and the glass substrate, wherein the encapsulant layer comprises an encapsulant component and a first encapsulant layer ultra violet (UV) absorber component, wherein the multilayer laminate structure comprises a lower ultra-violet light transmission (L-UVLT) of not greater than 1.0%, where the L-UVLT of the multilayer laminate structure is defined as the percent transmission between 200 nm and 360 nm, wherein the multilayer laminate structure comprises a high ultra-violet light transmission (H-UVLT) of not greater than 5.0%, where the H-UVLT of the multilayer laminate structure is defined as the percent transmission between 360 nm and 380 nm, and wherein the multilayer laminate structure comprises a visual light transmission (VLT) of at least about 50.0%, where the VLT of the multilayer laminate structure is defined as the percent transmission between 400 nm and 1100 nm.

Embodiment 47. The method of embodiment 46, wherein the multilayer film comprises a L-UVLT of not greater than about 0.95%.

Embodiment 48. The method of embodiment 46, wherein the multilayer film comprises a L-UVLT of at least about 0.0001%.

Embodiment 49. The method of embodiment 46, wherein the multilayer film comprises a H-UVLT of not greater than about 4.9%.

Embodiment 50. The method of embodiment 46, wherein the multilayer film comprises a H-UVLT of at least about 0.0001%.

Embodiment 51. The method of embodiment 46, wherein the multilayer film comprises a VLT of at least about 55.0%.

Embodiment 52. The method of embodiment 46, wherein the multilayer film comprises a VLT of not greater than about 99.9%.

Embodiment 53. The method of embodiment 46, wherein the glass substrate has a thickness of not greater than about 300 microns.

Embodiment 54. The method of embodiment 46, wherein the glass substrate has a thickness of at least about 1 micron.

Embodiment 55. The method of embodiment 46, wherein the fluoropolymer based material of the fluoropolymer based layer comprises a fluoropolymer.

Embodiment 56. The method of embodiment 55, wherein the fluoropolymer is selected from the group consisting of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, a copolymer of ethylene and trifluoroethylene, any blend thereof, and any alloy thereof.

Embodiment 57. The method of embodiment 46, wherein the fluoropolymer based layer comprises a fluoropolymer based material content of at least about 50 wt. % for a total weight of the fluoropolymer based layer.

Embodiment 58. The method of embodiment 46, wherein the fluoropolymer based layer comprises a fluoropolymer based material content of not greater than about 100% for a total weight of the fluoropolymer based layer.

Embodiment 59. The method of embodiment 46, wherein the fluoropolymer based layer consists of a fluoropolymer based material.

Embodiment 60. The method of embodiment 46, wherein the fluoropolymer based layer comprises an ETFE content of at least about 50 wt. % for a total weight of the fluoropolymer based layer.

Embodiment 61. The method of embodiment 46, wherein the fluoropolymer based layer comprises an ETFE content of not greater than about 100 wt. % for a total weight of the fluoropolymer based layer.

Embodiment 62. The method of embodiment 46, wherein the fluoropolymer based layer consists of an ETFE.

Embodiment 63. The method of embodiment 46, wherein the fluoropolymer based layer comprises a thickness of at least about 10 μm.

Embodiment 64. The method of embodiment 46, wherein the fluoropolymer based layer comprises a thickness of not greater than about 1000 μm.

Embodiment 65. The method of embodiment 46, wherein the encapsulant layer comprises an encapsulant component and a first encapsulant layer UV absorber component.

Embodiment 66. The method of embodiment 65, wherein the encapsulant layer comprises an encapsulant component content of at least about 35% wt. % for a total weight of the encapsulant layer.

Embodiment 67. The method of embodiment 65, wherein the encapsulant layer comprises an encapsulant component content of not greater than about 99.95 wt. % for a total weight of the encapsulant layer.

Embodiment 68. The method of embodiment 65, wherein the encapsulant component comprises an acrylic based polymer, a thermoplastic polyolefin (TPE), an ethyl vinyl acetate (EVA), a polyvinyl butyrate (PVB) or a silicone.

Embodiment 69. The method of embodiment 65, wherein the encapsulant layer comprises a first encapsulant layer UV absorber component content of at least about 0.05 wt. % for a total weight of the encapsulant layer.

Embodiment 70. The method of embodiment 65, wherein the encapsulant layer comprises a first encapsulant layer UV absorber component content of not greater than about 65 wt. % for a total weight of the encapsulant layer.

Embodiment 71. The method of embodiment 65, wherein the first encapsulant layer UV absorber component comprises a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

Embodiment 72. The method of embodiment 65, wherein the encapsulant layer comprises a second encapsulant layer UV absorber component.

Embodiment 73. The method of embodiment 72, wherein the encapsulant layer comprises a second encapsulant layer UV absorber component content of at least about 0.05 wt. % for a total weight of the encapsulant layer.

Embodiment 74. The method of embodiment 72, wherein the encapsulant layer comprises a second UV encapsulant layer absorber component content of not greater than about 65 wt. % for a total weight of the encapsulant layer.

Embodiment 75. The method of embodiment 72, wherein second encapsulant layer UV absorber component comprises a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

Embodiment 76. The method of embodiment 46, wherein the encapsulant layer comprises a thickness of at least about 30 μm.

Embodiment 77. The method of embodiment 46, wherein the encapsulant layer comprises a thickness of not greater than about 500 μm.

Embodiment 78. The method of embodiment 46, wherein the encapsulant layer comprises a corona-treated surface.

Embodiment 79. The method of embodiment 78, where the corona-treated surface contacts the fluoropolymer based layer.

Embodiment 80. The method of embodiment 46, wherein the multilayer film further comprises a PET layer, wherein the encapsulant layer is between the fluoropolymer based layer and the PET layer.

Embodiment 81. The method of embodiment 80, wherein the PET layer comprises a thickness of at least about 0.1 μm.

Embodiment 82. The method of embodiment 80, wherein the PET layer comprises a thickness of not greater than about 1000 μm.

Embodiment 83. The method of embodiment 46, wherein the fluoropolymer based layer comprises a first fluoropolymer based layer UV absorber component.

Embodiment 84. The method of embodiment 83, wherein the fluoropolymer based layer comprises a first fluoropolymer based layer UV absorber component content of at least about 0.05 wt. % for a total weight of the fluoropolymer based layer.

Embodiment 85. The method of embodiment 83, wherein the fluoropolymer based layer comprises a first fluoropolymer based layer UV absorber component content of not greater than about 65 wt. % for a total weight of the fluoropolymer based layer.

Embodiment 86. The method of embodiment 83, wherein the first fluoropolymer based layer UV absorber component comprises a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

Embodiment 87. The method of embodiment 83, wherein the fluoropolymer based layer comprises a second fluoropolymer based layer UV absorber component.

Embodiment 88. The method of embodiment 87, wherein the fluoropolymer based layer comprises a second fluoropolymer based layer UV absorber component content of at least about 0.05 wt. % for a total weight of the fluoropolymer based layer.

Embodiment 89. The method of embodiment 87, wherein the fluoropolymer based layer comprises a second fluoropolymer based layer UV absorber component content of not greater than about 65 wt. % for a total weight of the fluoropolymer based layer.

Embodiment 90. The method of embodiment 87, wherein second fluoropolymer based layer UV absorber component comprises a benzophenone, a benzotriazole, a triazine, a cyanoacrylate, an oxanilide, a benzoxaxinone, a metal oxide including but not limited to titanium oxides, zinc oxides, and iron oxides, a metal halide, or a metal sulfide.

### EXAMPLES

The concepts described herein will be further described in the following Examples, which do not limit the scope of the invention described in the claims.

### Example 1

Sample multilayer films S1-S15 were configured and formed according to certain embodiments described herein.

For each sample multilayer film S1-S15, a UV blocking encapsulant film is laminated between a fluoropolymer layer and a PET/glass layer using a combination of heat and pressure to bond the materials. The fluoropolymer layer may additionally have UV absorbers incorporated into that layer.

Further configuration and composition details of each sample multilayer film S1-S15 are summarized in Table 1 below.

TABLE 1
Sample Multilayer Film Configuration and Composition

| | Fluoropolymer | PET | Total UV Absorber |
|---|---|---|---|
| | Based Layer | Substrate | Component - Dry- |
| Sample | Thickness | Thickness | (wt. % for total weight |
| No. | (mil) | (mil) | of adhesive mixture) |
| S1 | 2 | 2 | 8.00 |
| S2 | 2 | 2 | 13.33 |
| S3 | 2 | 2 | 26.67 |
| S4 | 2 | 2 | 40.00 |
| S5 | 2 | 2 | 53.33 |
| S6 | 2 | 2 | 66.67 |
| S7 | 2 | 2 | 15.83 |
| S8 | 2 | 2 | 31.67 |
| S9 | 2 | 2 | 47.50 |
| S10 | 2 | 2 | 63.33 |
| S11 | 2 | 2 | 69.67 |
| S12 | 1.5 | 4 | 5.83 |
| S13 | 2 | 2 | 17.5 |
| S14 | 2 | 2 | 58.33 |
| S15 | 2 | 2 | 70.00 |

Performance properties of each sample multilayer film S1-S15 are summarized in Table 2 below. The summarized performance properties include the lower ultraviolet light transmission (L-UVLT) of the multilayer film, where the L-UVLT of the multilayer film is defined as the percent transmission between 200 nm and 360 nm, the high ultraviolet light transmission (H-UVLT) of the multilayer film, where the H-UVLT of the multilayer film is defined as the percent transmission between 360 nm and 380 nm, and the visual light transmission (VLT) of the multilayer film, where the VLT of the multilayer film is defined as the percent transmission between 400 nm and 1100 nm.

TABLE 2
Performance Properties

| Sample No. | L-UVLT (%) | H-UVLT (%) | VLT (%) |
|---|---|---|---|
| S1 | 0.233 | 1.485 | 85.915 |
| S2 | 0.079 | 0.037 | 86.756 |
| S3 | 0.078 | 0.013 | 85.843 |
| S4 | 0.978 | 0.098 | 88.290 |
| S5 | 0.078 | 0.015 | 84.202 |
| S6 | 0.921 | 0.160 | 89.572 |
| S7 | 0.115 | 1.837 | 87.454 |
| S8 | 0.101 | 0.454 | 87.256 |
| S9 | 0.038 | 0.142 | 90.308 |
| S10 | 0.074 | 0.033 | 87.237 |
| S11 | 0.948 | 0.108 | 90.023 |
| S12 | 0.344 | 4.413 | 87.107 |
| S13 | 0.105 | 3.383 | 87.041 |
| S14 | 0.864 | 0.083 | 89.207 |
| S15 | 0.017 | 0.016 | 89.148 |

### Example 2

Sample multilayer films S16-S27 were configured and formed according to certain embodiments described herein.

For each sample multilayer films S16-S27, an ultraviolet (UV) absorber component is compounded into an ETFE resin using a twin screw extruder and pelletized. The pelletized material is then extruded to make an ETFE film. Further, a UV blocking encapsulant film is laminated between a fluoropolymer layer and a PET/glass layer using a combination of heat and pressure to bond the materials. The fluoropolymer layer may additionally have UV absorbers incorporated into that layer.

Further configuration and composition details of each sample multilayer film S16-S27 are summarized in Table 3 below.

TABLE 3
Sample Multilayer Film Configuration and Composition

| | Fluoropolymer | Total UV Absorber |
|---|---|---|
| | Based Layer | Component - Dry- |
| | Thickness | (wt. % for total weight of |
| Sample No. | (mil) | fluoropolymer based layer) |
| S16 | 2 | 3.0 |
| S17 | 2 | 5.0 |
| S18 | 2 | 7.0 |
| S19 | 2 | 10.0 |
| S20 | 2 | 12.0 |
| S21 | 2 | 12.0 |
| S22 | 2 | 6.0 |
| S23 | 2 | 6.0 |
| S24 | 2 | 7.0 |
| S25 | 2 | 7.0 |
| S26 | 2 | 7.0 |
| S27 | 2 | 7.0 |

Performance properties of each sample multilayer film S16-S27 are summarized in Table 4 below. The summarized performance properties include the lower ultraviolet light transmission (L-UVLT) of the multilayer film, where the L-UVLT of the multilayer film is defined as the percent transmission between 200 nm and 360 nm, the high ultraviolet light transmission (H-UVLT) of the multilayer film, where the H-UVLT of the multilayer film is defined as the percent transmission between 360 nm and 380 nm, and the visual light transmission (VLT) of the multilayer film, where the VLT of the multilayer film is defined as the percent transmission between 400 nm and 1100 nm.

TABLE 4
Performance Properties

| Sample No. | L-UVLT (%) | H-UVLT (%) | VLT (%) |
|---|---|---|---|
| S16 | 0.541 | 0.178 | 75.633 |
| S17 | 0.207 | 0.049 | 74.004 |
| S18 | 0.093 | 0.023 | 63.032 |
| S19 | 0.158 | 0.048 | 73.930 |
| S20 | 0.189 | 0.071 | 70.783 |
| S21 | 0.150 | 0.035 | 72.149 |
| S22 | 0.092 | 0.513 | 68.841 |
| S23 | 0.068 | 0.452 | 68.183 |
| S24 | 0.034 | 0.119 | 61.434 |
| S25 | 0.091 | 0.298 | 61.668 |
| S26 | 0.350 | 1.738 | 73.982 |
| S27 | 0.080 | 0.522 | 67.204 |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayer laminate structure comprising:
a glass substrate having a thickness of not greater than about 300 microns,
an fluoropolymer based layer comprising a fluoropolymer based material, and
an encapsulant layer in contact with the glass substrate and the fluoropolymer based layer,
wherein the encapsulant layer comprises an encapsulant component and a first encapsulant layer ultra violet (UV) absorber component,
wherein the multilayer laminate structure comprises a lower ultra-violet light transmission (L-UVLT) of not greater than 1.0%, where the L-UVLT of the multilayer laminate structure is defined as the percent transmission between 200 nm and 360 nm,
wherein the multilayer laminate structure comprises a high ultra-violet light transmission (H-UVLT) of not greater than 5.0%, where the H-UVLT of the multilayer laminate structure is defined as the percent transmission between 360 nm and 380 nm, and
wherein the multilayer laminate structure comprises a visual light transmission (VLT) of at least about 50.0%, where the VLT of the multilayer laminate structure is defined as the percent transmission between 400 nm and 1100 nm.

2. The multilayer laminate structure of claim 1, wherein the multilayer laminate structure comprises a L-UVLT of not greater than about 0.95%.

3. The multilayer laminate structure of claim 1, wherein the multilayer laminate structure comprises a L-UVLT of at least about 0.0001%.

4. The multilayer laminate structure of claim 1, wherein the multilayer laminate structure comprises a H-UVLT of not greater than about 4.9%.

5. The multilayer laminate structure of claim 1, wherein the multilayer laminate structure comprises a H-UVLT of at least about 0.0001%.

6. The multilayer laminate structure of claim 1, wherein the multilayer laminate structure comprises a VLT of at least about 55.0%.

7. The multilayer laminate structure of claim 1, wherein the multilayer laminate structure comprises a VLT of not greater than about 99.9%.

8. The multilayer laminate structure of claim 1, wherein the glass substrate has a thickness of not greater than about 300 microns.

9. The multilayer laminate structure of claim 1, wherein the glass substrate has a thickness of at least about 1 micron.

10. The multilayer laminate structure of claim 1, wherein the fluoropolymer based material of the fluoropolymer based layer comprises a fluoropolymer.

11. The multilayer laminate structure of claim 10, wherein the fluoropolymer is selected from the group consisting of ethylene propylene copolymer (FEP), a copolymer of ethylene and fluorinated ethylene propylene (EFEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), polyvinylidene fluoride (PVDF), a terpolymer including tetrafluoroethylene, hexafluoropropylene, and vinylidenefluoride (THV), a terpolymer of tetrafluoroethylene, hexafluoropropylene, and ethylene (THE), a copolymer of chlorotrifluoroethylene and vinylidenefluoride, a copolymer of ethylene and trifluoroethylene, any blend thereof, and any alloy thereof.

12. The multilayer laminate structure of claim 1, wherein the fluoropolymer based layer comprises a fluoropolymer based material content of at least about 50 wt. % for a total weight of the fluoropolymer based layer.

13. The multilayer laminate structure of claim 1, wherein the fluoropolymer based layer comprises a fluoropolymer based material content of not greater than about 100% for a total weight of the fluoropolymer based layer.

14. The multilayer laminate structure of claim 1, wherein the fluoropolymer based layer consists of a fluoropolymer based material.

15. The multilayer laminate structure of claim 1, wherein the fluoropolymer based layer comprises an ETFE content of at least about 50 wt. % for a total weight of the fluoropolymer based layer.

16. The multilayer laminate structure of claim 1, wherein the fluoropolymer based layer comprises an ETFE content of not greater than about 100 wt. % for a total weight of the fluoropolymer based layer.

17. The multilayer laminate structure of claim 1, wherein the fluoropolymer based layer consists of an ETFE.

18. The multilayer laminate structure of claim 1, wherein the fluoropolymer based layer comprises a thickness of at least about 10 μm.

19. The multilayer laminate structure of claim 1, wherein the fluoropolymer based layer comprises a thickness of not greater than about 1000 μm.

20. A method of forming a multilayer laminate structure, wherein the method comprises:
providing a glass substrate having a thickness of not greater than about 300 microns,
providing a fluoropolymer based layer,
forming an encapsulant layer so that it is in contact with the fluoropolymer based layer,
attaching the encapsulant layer to the glass substrate so that the encapsulant layer is between the fluoropolymer based layer and the glass substrate,
wherein the encapsulant layer comprises an encapsulant component and a first encapsulant layer ultra violet (UV) absorber component,
wherein the multilayer laminate structure comprises a lower ultra-violet light transmission (L-UVLT) of not greater than 1.0%, where the L-UVLT of the multilayer laminate structure is defined as the percent transmission between 200 nm and 360 nm,
wherein the multilayer laminate structure comprises a high ultra-violet light transmission (H-UVLT) of not greater than 5.0%, where the H-UVLT of the multilayer laminate structure is defined as the percent transmission between 360 nm and 380 nm, and
wherein the multilayer laminate structure comprises a visual light transmission (VLT) of at least about 50.0%, where the VLT of the multilayer laminate structure is defined as the percent transmission between 400 nm and 1100 nm.
